(19) United States
(12) Patent Application Publication
(10) Pub. No.: US 2021/0368692 A1
(43) Pub. Date: Dec. 2, 2021

(54) SYSTEM, METHOD AND APPARATUS FOR ABOVE-GROUND SUSPENSION AND SELF-BALANCING CROP CONTAINERS

(71) Applicant: Ningbo Holby Agricultural Science & Technology Co., Ningbo City (CN)

(72) Inventors: Israel Holby, Ningbo City (CN); Shi Ji, Ningbo City (CN); Guo Qiang, Ningbo City (CN); Wang Chen, Ningbo City (CN)

(73) Assignee: Ningbo Holby Agricultural Science & Technology Co., Ningbo City (CN)

(21) Appl. No.: 17/332,717

(22) Filed: May 27, 2021

(30) Foreign Application Priority Data
May 28, 2020 (CN) 202020934074.3
Jan. 11, 2021 (CN) 2021100321731.0

(51) Int. Cl. A01G 9/14; A01G 9/02

(52) U.S. Cl. CPC A01G 9/1423; A01G 9/027

(57) ABSTRACT

A system for suspending and self-balancing containers of crops includes first and second support rods and two cables tensioned between them. The two cables are connected to each other to form a closed-loop cable system. Support members for supporting the closed-loop cable system are coupled to the first and second support rods. Each support member includes a first arc-shaped surface. The closed-loop cable system is tensioned against the first arc-shaped surfaces. When the closed-loop cable system is under stress, it can facilitate the self-adjustment of the height of the cables by a relative sliding motion between the closed-loop cable system and the first arc-shaped surfaces.

The present disclosure generally relates to planting and growing agricultural products and, in particular, to a system, method and apparatus for suspending and self-balancing crops.

### BACKGROUND ART

Currently, the biggest challenge in the development of the agricultural product growing industry is unified and systematic management. Traditional techniques for agricultural products involve planting and growing crops in the ground. However, there are several problems with such ground-based techniques. For example, ground-based soil can propagate soil-borne diseases that can infect crops. In addition, ground-based operations are more intensive for farmers.

Although systems for the above-ground suspension of crops are known, all of them are similarly fixed to hangers. They use carriers, such as pots, that are directly suspended on rigid hangers or hanging rods. They are suitable for small-batch planting, or for cultivation on a personal balcony. In the case of large-scale commercial planting, however, a large number of hangers or hanging rods is needed, which can be cost prohibitive. Accordingly, improvements in hanging systems for plants continue to be of interest.

### DETAILED DESCRIPTION OF THE INVENTION

Considering the shortcomings of the above-mentioned prior art, this disclosure provides a system for self-balancing, hanging plants that can facilitate the operations required by farmers while making the crops stable when they are hung.

Embodiments of the system for self-balancing, hanging plants include first and second support rods and two cables tensioned between them. A carrier for the plants is hung on the cables. The two cables are coupled together to form a closed-loop cable system. A supporting member for supporting the closed-loop cable system can be arranged at least on one of the first and second support rods. The supporting member can include a first arc-shaped surface. The closed-loop cable system can be mutually pressed against the first arc-shaped surface. When the closed-loop cable system is in tension, the closed-loop cable system can realize the self-adjustment of the height of the two cables by a relative sliding between the closed-loop cable system and the first arc-shaped surface.

Some embodiments include a suspended hanging method for planting crops. The carrier can be hung on the cable so that the crops or plants are separated from the ground soil, thereby increasing the planting height of the crops. The farmers do not need to bend over when managing the elevated crops or plants, which reduces the intensity of the farming operation.

Embodiments of the carrier can be separated from the ground soil, which prevents the crops from being infected by soil-borne diseases, thereby improving the quality of the plants.

In some embodiments, the carrier can be hung on two cables, if the two cables have a height difference, or the two cables are under different tensions, the carrier on the cables can tilt, and even overturn. Therefore, to ensure that the suspended crops are more stable, the two cables are mutually connected to form a closed-loop cable so that self-adjustment between the two cables can be realized, which can better ensure that the tension in the two cables is consistent.

Finally, the cables usually comprise steel wire, iron wire and other materials. When conventional cables are in high tension and make contact with a sharp corner or other object, they can bear excessive resistance, which can result in unsmooth sliding. In contrast, the disclosed embodiments can include a support member for supporting the closed-loop cable system on at least one of the first and second support rods. Since the support member comprises a first arc-shaped surface, the main force-bearing component of the cables is the first arc-shaped surface. The resistance caused by the first arc-shaped surface to the closed-loop cable system is relatively small. When the closed-loop cable system is tensioned by a direct force, the closed-loop cable system slides relatively smoothly on the arc-shaped surface, so that self-adjustment of the height of the two cables can be achieved by a relative sliding movement between the closed-loop cable system and the first arc-shaped surface. This ensures that the tension between the two cables tends to be consistent, as is the height of the two cables.

Embodiments of the supporting member can comprise an arc-shaped plate that is fixed on the first or second support rod. The first arc-shaped surface can be formed on the arc-shaped plate.

In some versions, a position portion can be coupled to the arc-shaped plate to prevent excessive horizontal movement of the two cables.

Some embodiments of the support member can comprise a pulley, with the closed-loop cable system arranged on the pulley. The first arc-shaped surface can be formed on a circumferential surface of the pulley.

In some versions, the two cables can be coupled to one pulley. Alternatively, the support member can comprise first and second pulleys, and the two cables can be respectfully coupled to them.

In another example, the two cables can be coupled to each other to form a closed-loop cable system and a pull end, under force, can be formed at one end of the closed-loop cable system. The pull end can be used to tighten the connection to a fixed end.

Embodiments of a connecting member can be arranged at the pull end. The fixed end can comprise an anchor structure, such as the ground or the wall. The connecting member cab be connected to the fixed end through a connecting rope, for example.

An example of the connecting member can comprise a second arc-shaped surface, and the cable can be arranged on the second arc-shaped surface.

In another example, the first and/or second support rod are installed in the ground, and are tilted relative to the ground.

In some embodiments, a water collecting tank can be arranged between the first and second support rods, such that the water collecting tank is located below the two cables.

The characteristics and advantages of the embodiments are disclosed in detail in the descriptions of the following examples and drawings.

### DESCRIPTION OF THE ATTACHED DRAWINGS

FIG. 1 is an isometric view of an embodiment of a system for self-balancing, hanging plants.

FIG. 2 is a side view of the embodiment of FIG. 1, shown installed in the ground.

FIG. 3 is an enlarged isometric view of portion A shown in FIG. 1.

FIG. 4 is an exploded isometric view of embodiments of the components shown in FIG. 3.

FIGS. 5 and 7 is an isometric view of an embodiment of a system for self-balancing, hanging plants.

FIG. 6 is an enlarged isometric view of portion C shown in FIG. 5.

FIG. 8 is a side view of an embodiment of a suspension-type planting system.

FIG. 9 is an isometric view of the system of FIG. 7.

FIG. 10 is an enlarged isometric view of a portion D shown in FIG. 8.

FIG. 11 is an enlarged isometric view of a portion E shown in FIG. 8.

FIG. 12 is an isometric view of an embodiment of a suspension member.

### DETAILED DESCRIPTION OF EMBODIMENTS

With reference to the drawings, embodiments and technical solutions of the embodiments are explained and described as follows. However, the following embodiments represent only some version and do not comprise every solution. Other embodiments may be ascertained by those skilled in the art and should be included in the scope of protection.

In the following description, it should be understand that the terms “inner”, “outer”, “upper”, “lower”, “left”, “right”, etc., refer to the direction or position. The terms are provided only for the convenience of describing the embodiments and simplifying the description, rather than indicating or implying that the device or element referred therein must have a specific direction, must be constructed or operated in a specific direction, they cannot be construed as a required limitation.

### Embodiment 1

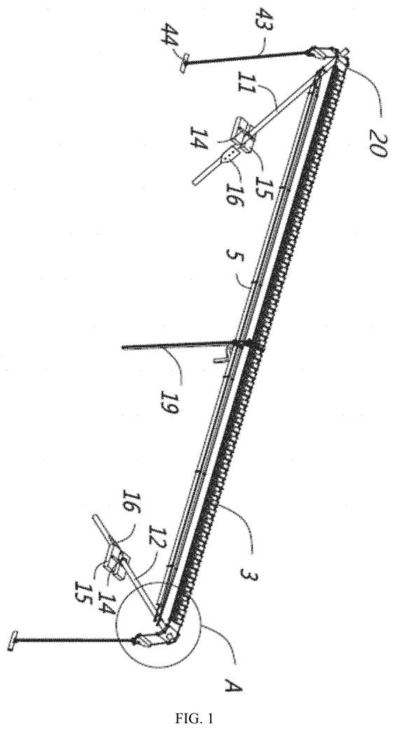

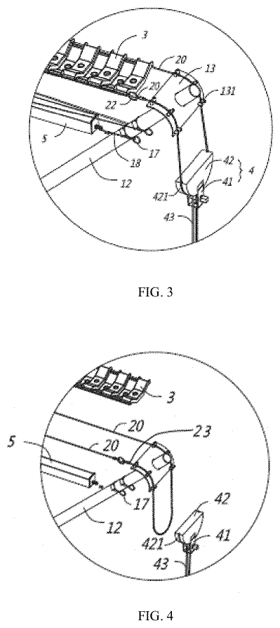

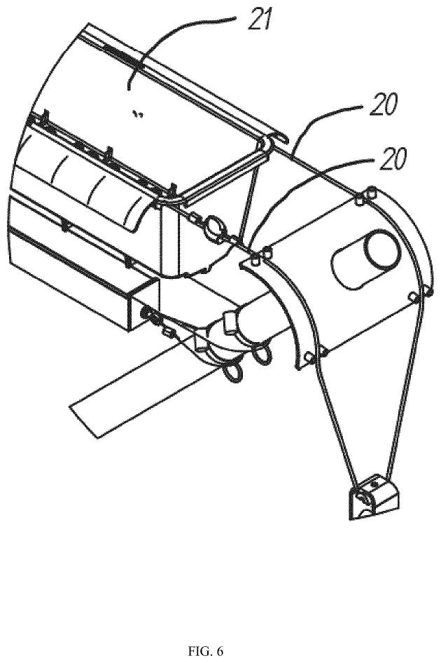

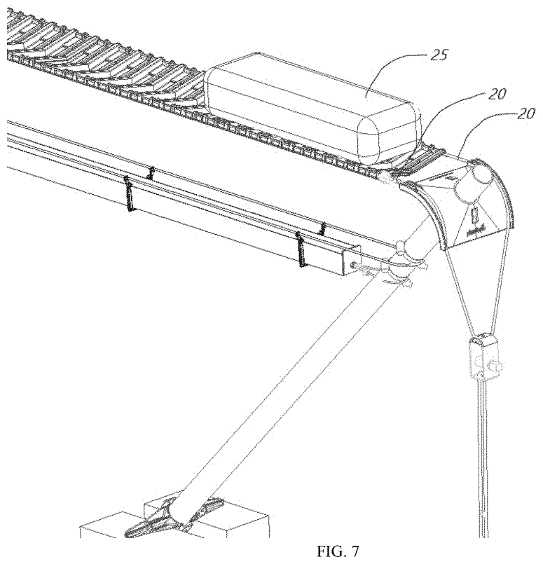

As shown in FIGS. 1-7, embodiments include a self-balancing, hanging planting device, which can be used for mass planting of crops, such as strawberries. The embodiments are suitable for environments such as greenhouses. Versions can further comprise a first support rod 11, a second support rod 12 and one or two cables 20 tensioned between the first support rod 11 and the second support rod 12. The distance between the first support rod 11 and the second support rod 12 can be 10 meters or more. A carrier (see, e.g., the carriers in FIGS. 5-8) for planting plants can be hung on the cables 20. In general, the carrier comprises a container to contain one or more plants. For example, the container may be a planting pot 21 or a bracket 3. A substrate bag 25 can be placed on top of the bracket 3, as shown in FIGS. 3-4 and 7. The one or two cables 20 are coupled or connected to each other to form a closed-loop cable system. A support member 13 can support the closed-loop cable system on at least on one of the first support rod 11 and/or the second support rod 12. The support member 13 can include a first arc-shaped surface, and the closed-loop cable system can be mutually pressed against the first arc-shaped surface. When the closed-loop cable system is under stress (e.g., tension), the closed-loop cable system can facilitate the self-adjustment of the height of the two cables 20 by a relative sliding motion between the closed-loop cable system and the first arc-shaped surface of support member 13.

In some embodiments, a suspended hanging method is adopted for planting crops. The carriers can be hung on the cables so that the crops or plants are separated from the ground soil. This increases the planting height of the crops so that the farmers of the crops do not need to bend over when managing the crops or plants, which reduces the operating intensity and requirements. In addition, these embodiments enable the carrier to be separated from the ground soil, which prevents the crops from infectious, soil-borne diseases, thereby improving the planting quality.

Furthermore, the carriers can be hung on the one or two cables 20. If the two cables 20 have a height difference, or the two cables 20 are under different tensions, they can cause the carriers that are hung on the two cables 20 to tilt or even overturn. Therefore, to ensure the crops hanging above the ground are more stable, the ends of the one or two cables 20 are mutually connected to form a closed-loop cable system. The two cables 20 can be connected to each other to form a single, integral, continuous cable 20, so that self-adjustment between the two cables 20 can be provided, which can ensure that the tightness of or tension in the two cables 20 remains consistent.

Embodiments of the cables 20 can comprise steel wire, iron wire and other materials. When high tension is applied to the cables 20, and if the cables 20 contact a sharp corner or other sharp object, the cables 20 can bear excessive resistance to movement at the sharp corners. This can result in unsmooth sliding of the cables 20. Embodiments of the support member 13 for supporting the cables 20 can be on at least one of the first support rod 11 or the second support rod 12. The support member 13 can have a first arc-shaped surface. In some embodiments, both the first support rod 11 and the second support rod 12 are each provided with a support member 13. The main force-bearing component for the cables 20 can be the first arc-shaped surface of their respective support members 13. The resistance caused by the first arc-shaped surface to the closed-loop cable system can be relatively small. Thus, when the closed-loop cable system is tensioned by a direct force (such as an impact with a sharp corner of some other component), the closed-loop cable system slides relatively smoothly on the first arc-shaped surfaces, so that self-adjustment of the height of the two cables 20 can be achieved by a relative sliding between the closed-loop cable and system the arc-shaped surfaces. This arrangement can maintain consistent tension between the two cables 20, as well as a consistent height of the two cables 20.

Embodiments of the supporting member 13 can comprise an arc-shaped plate. The arc-shaped plates can be fixed on the first support rod 11 and the second support rod 12, respectively. In one embodiment, both the first support rod 11 and the second support rod 12 are provided with the supporting member 13. The arc-shaped plate can be arranged on both the first support rod 11 and the second support rod 12. A first arc-shaped surface can be formed on the arc-shaped plate. As shown in FIG. 3, the first arc-shaped surface can guide the cable 20 from a horizontal direction to a downward direction. The cable 20 can be guided obliquely downward or vertically downward. This structure has a lower cost. The support member 13 can be only on the first support rod 11 or only on the second support rod 12, or on both. It can be welded and/or installed, such as by assembly.

To ensure that the horizontal position of the two cables 20 on the arc-shaped plates is relatively fixed, a position portion can be arranged on the arc-shaped plates. The carrier for the plants can be hung on the two cables 20. The system also maintains the lateral distance between the two cables 20. In some embodiments, the position portion can be a convex column group 131 that is arranged on the arc-shaped plate. The convex column group 131 can include two convex columns, with each cable 20 is located between the two convex columns, respectively. The quantity of the convex column group 131 is determined and selected according to actual needs.

The structure of the support member 13 is not limited to the arc-shaped plate. It also can be other shapes and structures, such as those described in other embodiments.

In some embodiments, a pull end 23 under force is formed at one end of the closed-loop cable system. The pull end can be subjected to direct force. The pull end can be used to tighten the connection to a fixed end. Embodiments of the pull end can be formed at both ends of the closed-loop cable system. When a force is applied to the pull end, the force can be directly transmitted to the two cables 20. The two cables 20 can naturally form self-regulation at the two sides of the pull end. The fixed end may be an anchoring source, such as the ground, a wall or other fixed positions. In some embodiment, the ground can be the fixed end, which can be a soil layer 100.

To facilitate fixing the pull end to the ground, a connect member 4 can be arranged at the pull end. The connect member 4 can be connected to the fixed end by a connecting rope 43. The connecting member 4 and the fixed end can be tensioned by using the connecting rope 43 on the other end. This design enables a reduction in the closed loop cable system to enhance the self-adjusting ability of the overall system. The connecting member 4 can increase the self-adjusting ability of the system.

To reduce the resistance between the closed-loop cable system and the connecting member 4, embodiments of the connecting member 4 can comprise a second arc-shaped surface 421. The cable 20 can be arranged on the second arc-shaped surface 421. After the second arc-shaped surface 421 is employed, the pull end can be tightened by the connecting member 4, such that the closed-loop cable system moves smoothly on the second arc-shaped surface 421. This design prevents the closed-loop cable system from having a high resistance at the connecting member 4 to better maintain the self-adjusting ability between the two cables 20.

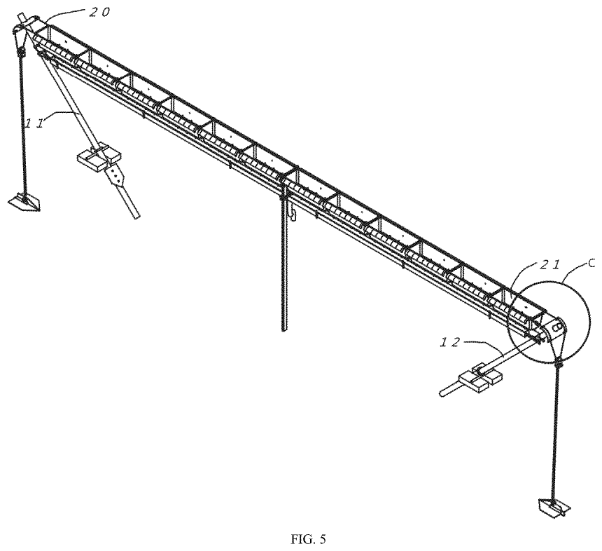

As shown in FIGS. 3-4, the connecting member 4 in the embodiment comprises a connecting buckle 41 and a connecting slider 42. The connecting buckle 41 and the connecting slider 42 can be mutually connected. In some embodiments, the connecting buckle 41 and the connecting slider 42 are detachably connected. The connecting slider 42 can be a semicircular plate, and a circumferential arc of the semicircular plate can form a second arc-shaped surface 421. To prevent the closed-loop cable system from separating from the connecting slider 42, a groove can be formed in a side surface of the semicircular plate. The closed loop cable can be positioned in the groove. When the connecting buckle 41 is tightened, the closed loop cable system seats in the groove. Since the groove itself also is arc-shaped, the closed loop cable system can slide smoothly in and through the groove. The friction or resistance between the groove and closed-loop cable system is relatively small.

After the overall installation is completed, it is optional to remove the connecting slider 42. The connecting slider 42 can be reused, if desired, so as to reduce costs. Further, the connecting buckle 41 described in one embodiment can be a gear tensioner, which is similar to a wire tensioning device having a ratchet structure. When a connecting rope 43 is wound on the gear tensioner, an indirect tension force is generated at the pull end of the closed-loop cable system. Currently, a number of gear tensioners have been disclosed and are available for sale in the market, so the specific structure of gear tensioner is not included here.

In one embodiment, both the first support rod 11 and/or the second support rod 12 are installed in the ground, and are tilted relative to the ground. In one embodiment, the closed-loop cable system is tensioned at both ends, and a first plant are hung in the middle of the cables 20. Additional plants are suspended adjacent to the first plant, the weight of the plants is concentrated midway between the first and second support rods 11, 12, which can cause the first support rod 11 and the second support rod 12 to be pulled toward the middle. If the first support rod 11 and the second support rod 12 were vertically installed in the ground, the first support rod 11 and the second support rod 12 would be too easily pulled toward the middle, and thereby enhance the sagging of the two cables 20 downward in the middle. In one embodiment, the first support rod 11 and the second support rod 12 are designed to be inclined. For example, the first support rod 11 has a top end facing outward and the bottom end facing inward so as to form a horizontal outward component force. The component force can offset a portion of the horizontal inward pull force caused when the cables 20 pull the first support rod 11 inward.

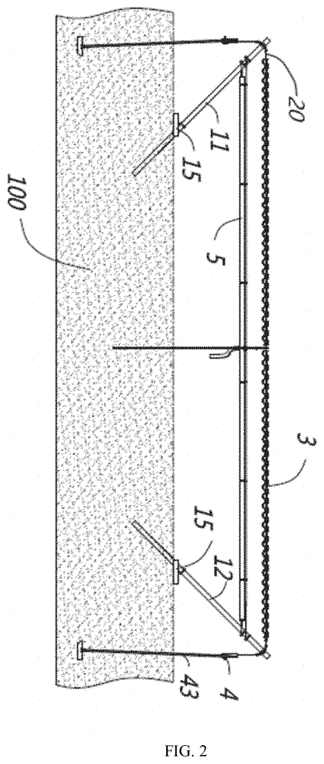

As shown in FIG. 2, a schematic diagram of the final installation, both the first support rod 11 and the second support rod 12 are partly inserted into the ground, and the bottom of the connecting rope 43 is also pre-buried into the ground. An anti-sinking structure can be included, respectively, for the first support rod 11 and the second support rod 12. For example, an anti-sinking crossbar 14 (FIG. 1) can be coupled to the first support rod 11 and the second support rod 12, respectively. In addition, a hard pressing block 15 is positioned on the ground adjacent to the anti-sinking crossbar 14. The pressing block 15 may comprise a brick. The anti-sinking crossbar 14 can be pressed against the pressing block 15 which, to some extent, can prevent the first support rod 11 and the second support rod 12 from sinking further into the ground. The first support rod 11 and the second support rod 12 may be subjected to significant downward forces. If the anti-sinking structure is not included in the assembly, the first support rod 11 may sink further into the ground. With the anti-sinking structure included, the contact areas of the first support rod and the second support rod 12 with the ground can be increased, thereby reducing the occurrence of such undesirable sinking situations.

Besides the anti-sinking structure design, an anti-overturning structure also can be included in some embodiments. An anti-overturning plate 16 can be coupled to the first support rod 11 and the second support rod 12, respectively. The anti-overturning plate 16 can be located in a plane that is perpendicular to a vertical plane where the cables 20 are located. The closed-loop cable system, when tightened, will act on the supporting members 13, which can be arc-shaped, thereby pulling the first support rod 11 and the second support rod 12 towards the middle. The tension can change the angles of inclination of the first support rod 11 and the second support rod 11. When the plants are suspended on the closed-loop cable system for a long period of time, these designs enable the system to support greater weight in the middle. Embodiments that include an anti-overturning structure enhance the contact area between the first support rod 11 and the second support rod 12 and the soil in an overturning direction. This design increases the overturning resistance of the first support rod 11 and the second support rod 12.

Embodiments also include installation methods. For example, the method can include the following steps:

S1. Install a ground anchor 44, to form a stable fixed end;

For the ground anchor 44, the type of the ground anchor 44 selected depends on the ground conditions. For example, if the soil is loose, a concrete ground anchor may be used. If the soil is hard, a metal ground anchor may be used. Taking the concrete ground anchor as an example, the method can include the following steps: dig a hole in the soil ground, place a concrete ground anchor 44 in the hole, connect a connecting rope 43 to the concrete ground anchor 44, extend the connecting rope 43 out to the ground surface, and then fill the hole with soil and compact it.

After these step, the connecting rope 43 can be pre-tensioned to maintain the connecting rope 43 pre-buried in the soil in a tightened state. This can prevent repositioning of the connecting rope 43 during subsequent tensioning;

S2. When installing the first support rod 11 and/or the second support rod 12, the steps can be as follows: insert the first support rod 11 and the second support rod 12 obliquely into the ground. A pile driver may be used to install the first support rod 11 and the second support rod 120, and keep a consistent height of the corresponding supporting members 13 on the first and second support rods 11, 12;

S3. Install the cables 20;

Embodiments of the cable 20 can be a full-rolled steel wire. One end of the cable 20 can be pulled from one end of the first support rod 11 to the second support rod 12, pass by the first arc-shaped surface on the supporting member 13 of the second support rod 12, and then pulled back to the first support rod 11. The cable can be wound around the first arc-shaped surface of the supporting member 13 of the first support rod 11. The two ends of the cable 20 can be connected together to form a single closed-loop cable. In one example, a steel wire connector 22 can be used for the connection.

Both sides of the first support rod 11 and the second support rod 12, in one embodiment, can include a connecting member 4. The connecting member 4 can comprise a connecting slider 42 with a second arc-shaped surface 421. The cable 20 passes the first support rod 11 and the second support rod 12, including the support members 13, it also passes along the second arc-shaped surface 421 on the connecting slider 42.

The cable 20 in one embodiment is a walking cable, which is flexible. The cable slides along the second arc-shaped surface 421 when being pulled, that is, the second arc-shaped surface 421 acts as a pulley, hence, actually the connecting slider 42 itself can be replaced by the pulley.

S4. Connect the closed-loop cable to the connecting rope, and tighten the closed-loop cable;

When tensioning, a dynamometer may be installed on the cable 20, and the gear tensioner on the connecting member 4 in the embodiment can be used for tensioning. In the step, there may be two cases as the connecting slider 42 can be removed in the final state, or not to be removed:

When the connecting slider 42 needs to be removed, the step may include a first tensioning and a second tensioning; in the first tensioning of the cable 20, the tensioning force can be maintained at 1500N to 2500N, generally 2000N, in some embodiments. In the second tensioning, remove the connecting slider 42 and then perform the second tensioning. Embodiments of the second tensioning force can be in a range of about 2600N to 3500N, or generally about 3000N,

If the connecting slider 42 does not need to be removed, in step S4, embodiments can include directly tension the closed-loop cable with a tensioning force in a range of about 2600N to 3500N, or generally about 3000N. The closed-loop cable can be directed through the gear tensioner on the connecting member 4.

S5. Some embodiments include installing a tank 6 (e.g., water collecting tank 5) between the first support rod 11 and the second support rod 12. For example, install the water collecting tank 5 under the cable 20. During installation, a height mark can be made on the first support rod 11 and the second support rod 12 to ensure that the initial height of the water collecting tank 5 at both ends remains consistent.

With regard to the installation of the water collecting tank 5, a hanging method can also be adopted, as shown in FIG. 3 and FIG. 4. A hanging ring 17 can be respectively installed on the first support rod 11 and the second support rod 12 for connecting a lower steel wire 18, from which the water collecting tank 5 can be hung.

If the distance between the first support rod 11 and the second support rod 12 is lengthy in some embodiment, one or more intermediate support rods 19 can be installed between the first support rod 11 and the second support rod 12. The number of intermediate support rods 19 can be selected and installed according to the actual needs.

S6. Embodiments also can include hanging the carrier on the cable 20, and then assemble the subsequent water inlet pipes and drain pipes.

Upon completion of all the assembly work, marks can be made on the first support rod 11 and the second support rod 12. The marks can be used to include the buried depth, the inclination, as well as to periodically observe any change of the marked parameters at later times. If the buried depth changes, this can indicate that there is sinking and a timely adjustment may be needed. If the inclination changes, this can indicate that the first support rod 11 and the second support rod 12 may be pulled and the cable 20 sagged, which also may need a timely adjustment.

### Embodiment 2

In other embodiments, the system can include one or more pulleys, such as a first pulley and a second pulley. In some versions, the pulleys can be V-type grooved wheels. Each pulley can include a first, arc-shaped surface formed on its circumferential surface. Such designs can enable the closed-loop cable to slide smoothly on the one or more pulleys.

Embodiments of the connecting member can include a connecting slider that is a pulley, e.g., the second pulley. A second, arc-shaped surface can be formed on the circumferential surface of a third pulley. Therefore, in this version, the closed-loop cable can be wound around three pulleys to form a structure similar to a triangular pulley block.

It should be noted that, the specific structures such as the support member and the connecting member can also adopt other embodiments, and the embodiments illustrated are only exemplary embodiments based on cost considerations.

The examples provided in this disclosure do not constrain the scope of protection. Technicians skilled in the art should understand that the embodiments include, but are not limited to, the attached drawings and the written descriptions. Any modifications that do not deviate from the functional and structural principles described herein will fall within in the scope of the claims.

### Embodiment 3

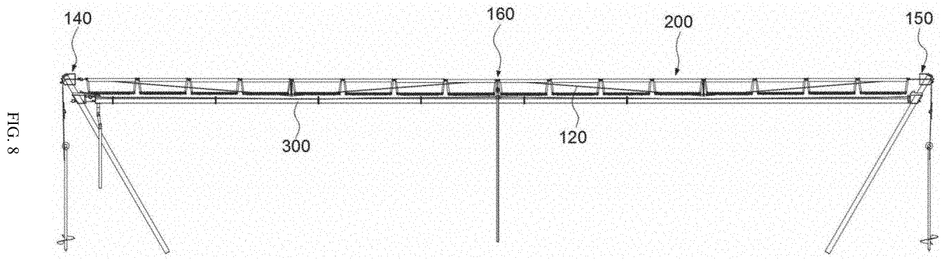

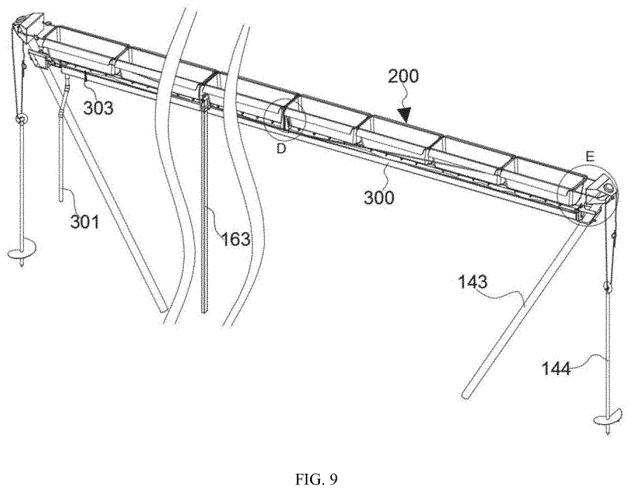

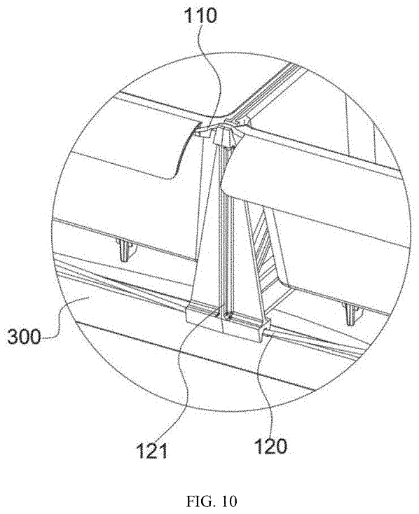

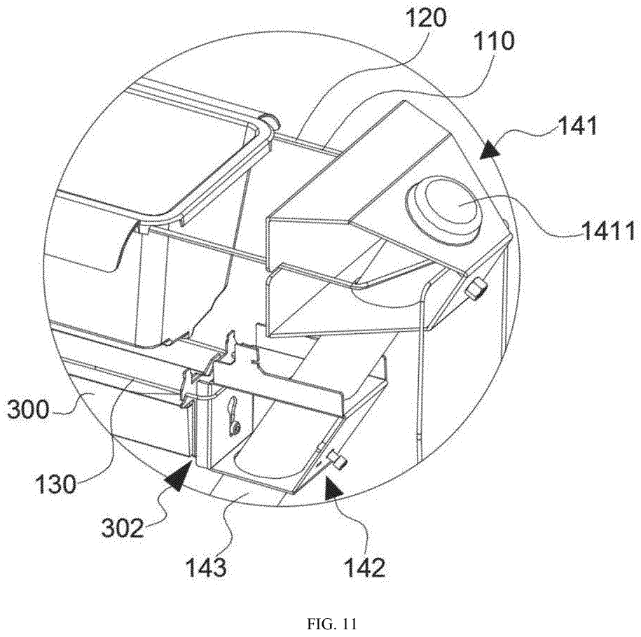

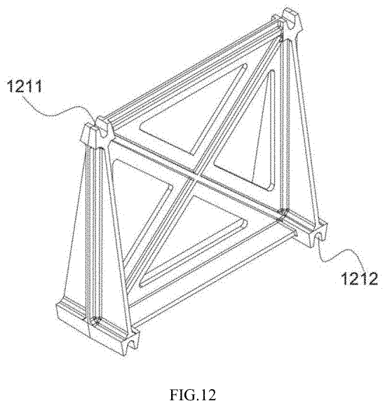

Referring to FIGS. 8-12, a suspension-type plants system is somewhat similar to the other embodiments. However, in this version, the suspension device can further include a second upper suspension member 120 and a suspension fixing member 121. Embodiments of the second upper suspension member 120 can include two second upper suspension steel wires arranged on both sides of the suspension device, respectively. The two second upper suspension steel wires can be fixedly connected to form a second upper suspension wire ring. The first end of the second upper suspension steel wire ring can pass through and be arranged at an upper end fixing member 141 of a first end support device. Versions of the second end of the second upper suspension steel wire ring can pass through and be arranged at an upper end fixing member of the second end support device 141. As shown in FIGS. 10 and 11, the suspension fixing member 121 can be arranged between adjacent plant pots. The top of the suspension fixing member 121 can be provided with a first groove 1211 for receiving a first upper suspension member 110, and the bottom thereof is provided with a second groove 1212 for receiving the second upper suspension member 120. The second upper suspension member 120 can pass through the second groove 1212 at the bottom of the suspension member to further support a planting pot set 200 (FIGS. 8-9) and prevent the planting pot set 200 from sagging due to gravity. The first end of a second upper suspension steel wire ring can pass through and can be arranged at the upper end fixing member 141 of the first end support device, and the second end thereof can pass through the second groove 1212 of the suspension fixing member 121, a fixing groove of an upper middle fixing member 161, and the second groove 1212 of the other suspension fixing member 121, and finally can pass through and be arranged at the upper end fixing member 141 of the second end support device.

In some embodiments, a suspension-type planting system can include a suspension device having a first upper suspension member 110, a first end fixing device 140, and a second end fixing device 150. The first upper suspension member 110 can be mounted between the first and second end fixing devices 140, 150. A planting pot set 200 can be mounted at the first upper suspension member 110, and the drainage groove 300 can be suspended and arranged under the planting pot set 200. In addition, a drainage groove 300 and the planting pot set 200 can be arranged at intervals. The term “intervals” can mean that there is space between the pot and gutter. This embodiment can improve the air permeability of the pot. Moreover, the roots of the plant cannot grow downward into the gutter. In contrast, some prior art designs allow the pots to contact the gutter. This can trap high humidity between them. The lack of light at their interface can cause the roots to grow into the gutter.

Embodiments of the suspension device can further include a lower suspension member 130 having a first end mounted at the lower end fixing member 142 of the first end fixing device 140. The second end of the lower suspension member 130 can be mounted at the lower end fixing member 142 of the second end fixing device 150. The drainage groove 300 can be mounted at the lower suspension member 130.

Some examples of the drainage groove 300 can include a middle suspension member 303 for suspending the drainage groove 300 at the lower suspension member 130. Versions of the middle suspension member 303 can include a cross rod and a vertical rod fixedly arranged at the both ends of the cross rod. The vertical rod can extend upward.

Embodiments of the suspension device also can have a middle fixing device 160 having a middle support rod 163, and an upper middle fixing member 161 that can be mounted at the middle support rod 163.

In some examples the first end fixing device 140 can have an end support rod 143, an upper end fixing member 141 sleeved on the end support rod 143, and a lower end fixing member 142 sleeved on the end support rod 143. The upper end fixing member 141 can be located above the lower end fixing member 142. Embodiments of the first end fixing device 140 can include a fixing anchor 144, and the fixing anchor 144 can be hinged with the upper end fixing member 141. The fixed anchor 144 can be arranged vertically. The end support rod 143 can be arranged obliquely. The top end of the end support rod 143 can be located away from the planting pot set 200. The bottom end thereof can face the planting pot set 200. The fixing anchor 144, the support rod and the ground together can form a triangular structure to make the support structure more stable. The fixing anchor 144 can be a spiral ground anchor. The structure of the second end fixing device 150 can be the same as that of the first end structure fixing device, in one example.

Versions of the upper end fixing member 141 can include a first plate parallel to the end support rod 143, a second plate fixedly arranged at the top end of the first plate, and a third plate fixedly arranged at the bottom end of the first plate. The first plate can be located on the side of the end support rod 143 away from the planting pot. The upper end bolt can pass through the first plate. By tightening the upper end bolt, the upper end bolt can be pressed against the end support rod 143. The upper end fixing member 141 can be fastened to the end support rod 143. The second plate can be perpendicular to the end support rod 143. The second plate can have a convex groove 1411 for receiving the end support rod 143 to prevent the upper end fixing member 141 and the end support rod 143 from relative displacement. In this way, the upper end fixing member 141 can be more firmly mounted at the end support rod 143. The third plate can be parallel to the ground. A first receiving hole for being passed through by the end support rod 143 can be provided at the third plate. The upper end fixing member 141 can be sleeved on the end support rod 143. This arrangement can help the upper end fixing member 141 to be firmly mounted at the end support rod 143 to prevent displacement. The upper end fixing member 141 can further include a fourth plate. The fourth plate can be located on the side of the support rod close to the planting pot. The top of the fourth plate can be fixedly connected to the first plate, and the bottom thereof can be fixedly connected to the third plate. The fourth plate can have a positioning groove for positioning the first upper suspension member 110. The first end of a first upper suspension steel wire ring can pass through the upper end fixing member 141 of the first end support device, and the second end of the first upper suspension steel wire ring can pass through the upper end fixing member of the second end support device 141.

In some embodiments, the bottom wall of the drainage groove 300 can have a drainage hole connected to a drainage pipe 301 to guide drainage. The two ends of the drainage groove 300 can have an end suspension member 302, respectively. A mounting bolt can be located at the first end of the drainage groove 300 close to the first end fixing device 140, which can secure to one end of a connecting steel wire, and the other end of the connecting steel wire can be fixedly arranged on the lower end fixing member 142 of the first end fixing device 140. The mounting bolt located at the second end of the drainage groove 300 close to the second end fixing device 150 can be fixedly provided with one end of a connecting bolt, and the other end of the connecting bolt can pass through and be arranged at the lower end fixing member 142 of the second end fixing device 150. With this arrangement, the drainage groove 300 can be more stably mounted at the suspension device.

Other embodiments may include one or more of the following items.

1. A system for suspending and self-balancing crop containers above a ground surface, the system comprising:

a first support rod;

a second support rod;

a cable tensioned between the first and second support rods, the cable has two ends that are coupled to each other to form a closed-loop cable;

a carrier configured to contain a plant is supported by the cable; and

support members supporting the closed-loop cable with the first and second support rods, each of the support members comprises a first arc-shaped surface, the closed-loop cable engages the first arc-shaped surfaces and, when the closed-loop cable is in tension, the closed-loop cable is configured to self-adjust a height thereof by a relative sliding motion between the closed-loop cable and the first arc-shaped surfaces.

2. The system wherein the first arc-shaped surfaces are on respective arc-shaped plates, and the arc-shaped plates are respectively coupled to the first and second support rods.

3. The system further comprising position portions respectively coupled to the arc-shaped plates to limit horizontal movement of the closed-loop cable.

4. The system wherein the support members comprise pulleys, the closed-loop cable is coupled to the pulleys, and the first arc-shaped surfaces are formed on respective circumferential surfaces of the pulleys.

5. The system wherein pull ends of the closed-loop cable are tensioned at ends thereof.

6. The system wherein connecting members are respectively coupled to the pull ends, the fixed ends are anchor structures, and the connecting members are connected to the fixed ends through respective connecting tethers.

7. The system wherein each of the connecting members comprises a second arc-shaped surface, and the closed-loop cable is coupled to the second arc-shaped surfaces.

8. The system wherein the first and second support rods are installed in the ground, and are tilted relative to the ground.

9. The system further comprising a tank for collecting liquid, the tank is coupled between the first and second support rods, and the tank is located below the carrier and the closed-loop cable.

10. A kit for suspending and self-balancing crop containers above a ground surface, the kit comprising:

a first support rod;

a second support rod;

a cable configured to be tensioned between the first and second support rods, the cable has two ends that are configured to be coupled to each other to form a closed-loop cable;

a carrier configured to be supported by the cable, and the carrier is configured to support crops; and

support members configured to support the closed-loop cable with the first and second support rods, each of the support members comprises a first arc-shaped surface, the closed-loop cable is configured to engage the first arc-shaped surfaces and, when the closed-loop cable is in tension, the closed-loop cable is configured to self-adjust a height thereof by a relative sliding motion between the closed-loop cable and the first arc-shaped surfaces.

11. The kit wherein the first arc-shaped surfaces are on respective arc-shaped plates, and the arc-shaped plates are configured to be respectively coupled to the first and second support rods.

12. The kit further comprising position portions configured to be respectively coupled to the arc-shaped plates to limit horizontal movement of the closed-loop cable.

13. The kit wherein the support members comprise pulleys, the closed-loop cable is configured to be coupled to the pulleys, and the first arc-shaped surfaces are formed on respective circumferential surfaces of the pulleys.

14. The kit wherein pull ends of the closed-loop cable are configured to be tensioned at ends thereof.

15. The kit wherein connecting members are configured to be respectively coupled to the pull ends, the fixed ends are anchor structures, and the connecting members are configured to be connected to the fixed ends through respective connecting tethers.

16. The kit wherein each of the connecting members comprises a second arc-shaped surface, and the closed-loop cable is configured to be coupled to the second arc-shaped surfaces.

17. The kit wherein the first and second support rods are configured to be installed in the ground, and are configured to be tilted relative to the ground.

18. The kit further comprising a tank configured to collect liquid and be coupled between the first and second support rods, and the tank is configured to be located below the carrier and the closed-loop cable.

19. A system for suspending and self-balancing crop containers above a ground surface, the system comprising:

a suspension device having a first upper suspension member (110), a first end fixing device (140), and a second end fixing device (150), wherein the first upper suspension member (110) is mounted between the first and second end fixing devices (140, 150);

a planting pot set (200) is mounted at the first upper suspension member (110);

a drainage groove (300) is suspended and arranged under the planting pot set (200).

What is claimed is:

1. A system for suspending and self-balancing crop containers above a ground surface, the system comprising:
a first support rod;
a second support rod;
a cable tensioned between the first and second support rods, the cable has two ends that are coupled to each other to form a closed-loop cable;
a carrier configured to contain a plant is supported by the cable; and
support members supporting the closed-loop cable with the first and second support rods, each of the support members comprises a first arc-shaped surface, the closed-loop cable engages the first arc-shaped surfaces and, when the closed-loop cable is in tension, the closed-loop cable is configured to self-adjust a height thereof by a relative sliding motion between the closed-loop cable and the first arc-shaped surfaces.

2. The system of claim 1, wherein the first arc-shaped surfaces are on respective arc-shaped plates, and the arc-shaped plates are respectively coupled to the first and second support rods.

3. The system of claim 2, further comprising position portions respectively coupled to the arc-shaped plates to limit horizontal movement of the closed-loop cable.

4. The system of claim 1, wherein the support members comprise pulleys, the closed-loop cable is coupled to the pulleys, and the first arc-shaped surfaces are formed on respective circumferential surfaces of the pulleys.

5. The system of claim 1, wherein pull ends of the closed-loop cable are tensioned at ends thereof.

6. The system of claim 5, wherein connecting members are respectively coupled to the pull ends, the fixed ends are anchor structures, and the connecting members are connected to the fixed ends through respective connecting tethers.

7. The system of claim 6, wherein each of the connecting members comprises a second arc-shaped surface, and the closed-loop cable is coupled to the second arc-shaped surfaces.

8. The system of claim 1, wherein the first and second support rods are installed in the ground, and are tilted relative to the ground.

9. The system of claim 1, further comprising a tank for collecting liquid, the tank is coupled between the first and second support rods, and the tank is located below the carrier and the closed-loop cable.

10. A kit for suspending and self-balancing crop containers above a ground surface, the kit comprising:
a first support rod;
a second support rod;
a cable configured to be tensioned between the first and second support rods, the cable has two ends that are configured to be coupled to each other to form a closed-loop cable;
a carrier configured to be supported by the cable, and the carrier is configured to support crops; and
support members configured to support the closed-loop cable with the first and second support rods, each of the support members comprises a first arc-shaped surface, the closed-loop cable is configured to engage the first arc-shaped surfaces and, when the closed-loop cable is in tension, the closed-loop cable is configured to self-adjust a height thereof by a relative sliding motion between the closed-loop cable and the first arc-shaped surfaces.

11. The kit of claim 10, wherein the first arc-shaped surfaces are on respective arc-shaped plates, and the arc-shaped plates are configured to be respectively coupled to the first and second support rods.

12. The kit of claim 11, further comprising position portions configured to be respectively coupled to the arc-shaped plates to limit horizontal movement of the closed-loop cable.

13. The kit of claim 10, wherein the support members comprise pulleys, the closed-loop cable is configured to be coupled to the pulleys, and the first arc-shaped surfaces are formed on respective circumferential surfaces of the pulleys.

14. The kit of claim 10, wherein pull ends of the closed-loop cable are configured to be tensioned at ends thereof.

15. The kit of claim 14, wherein connecting members are configured to be respectively coupled to the pull ends, the fixed ends are anchor structures, and the connecting members are configured to be connected to the fixed ends through respective connecting tethers.

16. The kit of claim 15, wherein each of the connecting members comprises a second arc-shaped surface, and the closed-loop cable is configured to be coupled to the second arc-shaped surfaces.

17. The kit of claim 10, wherein the first and second support rods are configured to be installed in the ground, and are configured to be tilted relative to the ground.

18. The kit of claim 10, further comprising a tank configured to collect liquid and be coupled between the first and second support rods, and the tank is configured to be located below the carrier and the closed-loop cable.

19. A system for suspending and self-balancing crop containers above a ground surface, the system comprising:
a suspension device having a first upper suspension member, a first end fixing device, and a second end fixing device, wherein the first upper suspension member is mounted between the first and second end fixing devices;
a planting pot set is mounted at the first upper suspension member;
a drainage groove is suspended and arranged under the planting pot set.
